(19) United States
(12) Patent Application Publication
(10) Pub. No.: US 2026/0061681 A1
(43) Pub. Date: Mar. 5, 2026

(54) INJECTION MOLDING MACHINE AND INJECTION MOLDING SYSTEM

(71) Applicant: SUMITOMO HEAVY INDUSTRIES, LTD., Tokyo (JP)

(72) Inventors: Tatsuya KAWAGUCHI, Chiba-shi (JP); Hirotsugu MARUMOTO, Tokyo (JP); Takuya MATSUNAGA, Chiba-shi (JP)

(21) Appl. No.: 19/240,931

(22) Filed: Jun. 17, 2025

(30) Foreign Application Priority Data
Sep. 4, 2024 (JP) 2024-152368

(51) Int. Cl. B29C 45/50; B29C 45/02; B29C 45/46; B29C 45/74; B29C 45/76

(52) U.S. Cl. CPC B29C 45/50; B29C 45/02; B29C 45/461; B29C 45/74; B29C 45/76; B29C 2945/76006; B29C 2945/76187; B29C 2945/76381; B29C 2945/76605; B29C 2945/76665; B29C 2945/76859

(57) ABSTRACT

An injection molding machine includes: a plasticizing cylinder that continuously receives a resin from a receiving portion into an inside, feeds the resin forward by rotating a screw, and delivers the resin fed forward to an outside by advancing the screw, in which even when the screw is advanced, the screw is rotated in the same direction as when the resin is fed forward.

### CROSS-REFERENCE TO RELATED APPLICATIONS

This application claims priority to Japanese Patent Application No. 2024-152368, filed on Sep. 4, 2024, which is incorporated by reference herein in its entirety.

### BACKGROUND

### Technical Field

A certain embodiment of the present invention relates to an injection molding machine and an injection molding system.

### Description of Related Art

An output unit that decontaminates contaminants contained inside a resin to be recycled and that outputs the resin as a molten resin and an injection molding machine that receives a supply of the molten resin that is output and that performs injection molding may be connected by a pipe (for example, the related art). In such an injection molding machine, there is an injection molding machine provided with a screw type cylinder that receives a resin output from an output unit from a receiving portion into the inside, rotates a screw mounted inside to feed the resin forward, and delivers the resin to the outside by advancing the screw. In such a screw type cylinder, the rotation of the screw stops when the screw is advanced.

### SUMMARY

According to an embodiment of the present invention, an injection molding machine includes a plasticizing cylinder that continuously receives a resin from a receiving portion into an inside, feeds the resin forward by rotating a screw, and delivers the resin fed forward to an outside by advancing the screw, in which even when the screw is advanced, the screw is rotated in the same direction as when the resin is fed forward.

Here, the injection molding machine may further include a screw controller that controls a rotational speed of the screw.

In addition, the screw controller may control the rotational speed of the screw so that the rotational speed of the screw when the resin is delivered is substantially the same as the rotational speed of the screw when a predetermined amount of resin is metered.

In addition, the screw controller may change the rotational speed of the screw in response to a change in an amount of resin received in the plasticizing cylinder, and control the rotational speed of the screw so that an amount of resin delivered from the plasticizing cylinder is substantially the same as the amount of resin received.

In addition, the injection molding machine may further include a pressure measurer that measures a pressure applied to the receiving portion of the resin, in which the screw controller may control the rotational speed of the screw in response to a magnitude of the pressure that is measured.

In addition, the screw controller may perform control to increase the rotational speed when the magnitude of the pressure that is measured is larger than a predetermined magnitude, and perform control to reduce the rotational speed when the magnitude of the pressure that is measured is smaller than the predetermined magnitude.

According to another embodiment of the present invention, an injection molding system includes an output unit that outputs a resin, and an injection molding machine that receives the resin that is output, plasticizes and melts the resin, injects the resin into a mold, and molds the resin with the mold, in which the injection molding machine includes a plasticizing cylinder that continuously receives the resin from a receiving portion into an inside, feeds the resin forward by rotating a screw, and delivers the resin fed forward to an outside by advancing the screw, and even when the screw is advanced, the screw is rotated in the same direction as when the resin is fed forward.

### BRIEF DESCRIPTION OF THE DRAWINGS

FIG. 1 is a diagram illustrating an example of an overall configuration of an injection molding system according to the present embodiment.

FIG. 2 is a graph illustrating the course of time of a control of a screw by a screw control unit of FIG. 1.

### DETAILED DESCRIPTION

While the rotation of the screw mounted inside the screw type cylinder is stopped, the flow of the resin existing inside the cylinder is stopped, and the resin stays inside the cylinder. In this case, in a case where the output unit continuously outputs the resin, the pressure applied to the receiving portion of the cylinder that receives the resin output from the output unit increases. When an attempt is made to feed a resin exceeding an amount that can be received by the cylinder into the inside of the cylinder, a situation may occur in which the molten resin leaks from a gap of the cylinder.

It is desirable to enable an injection molding machine having a screw type cylinder to continuously receive a resin serving as a molding material.

Hereinafter, an embodiment of the present invention will be described in detail with reference to the accompanying drawings.

### Configuration of Injection Molding System 1

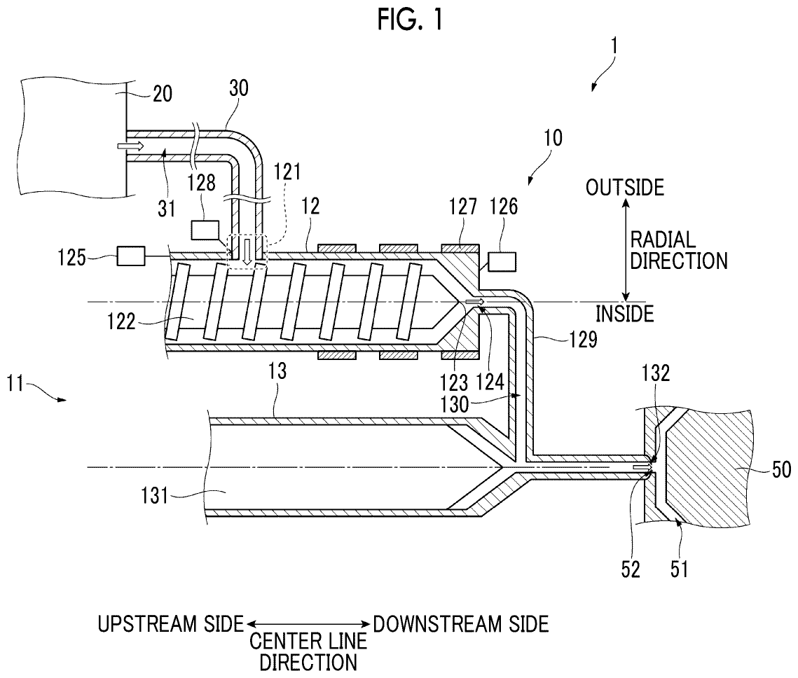

FIG. 1 is a diagram illustrating an example of an overall configuration of an injection molding system 1 according to the present embodiment.

The injection molding system 1 illustrated in FIG. 1 is a system configured to include an injection molding machine 10 that performs injection molding of a molding product using a resin as a material, an output unit 20 that continuously outputs the resin toward the injection molding machine 10, and a connecting pipe 30 that connects the output unit 20 and the injection molding machine 10. In the injection molding system 1, since the resin serving as the molding material is output from the output unit 20 toward the injection molding machine 10, the injection molding machine 10 as viewed from the output unit 20 is a unit disposed on a downstream side.

The injection molding machine 10 and the output unit 20 are connected to each other by the connecting pipe 30. The connecting pipe 30 is a metal pipe having a bent portion, and a space 31 serving as a flow path through which the resin output from the output unit 20 flows is formed therein. Therefore, the connecting pipe 30 has heat resistance and pressure resistance for causing the resin to flow. Furthermore, an inner surface of the connecting pipe 30 is smooth and has a non-staying structure in which the resin is unlikely to stay. The connecting pipe 30 has an end portion on an upstream side connected to the output unit 20 and an end portion on the downstream side connected to the injection molding machine 10. Therefore, as illustrated by an arrow in FIG. 1, the resin output from the output unit 20 is received in the injection molding machine 10 after flowing through the connecting pipe 30. The resin output from the output unit 20 in the present embodiment may be a molten resin which is a fluid, or may be a solid resin that is pulverized into a chip shape and is called a pellet.

### Injection Molding Machine 10

As described above, the injection molding machine 10 is a molding machine used for manufacturing a molding product using a resin as a material. The injection molding machine 10 is connected to the output unit 20 via the connecting pipe 30. Therefore, the injection molding machine 10 receives the resin output from the output unit 20 via the connecting pipe 30, and enables the molding product to be manufactured using the received resin as a material. The injection molding machine 10 includes an injection unit 11 and a mold 50.

### Injection Unit 11

The injection unit 11 is a unit that plasticizes a resin, which is a molding material, performs metering of the resin in a molten state, and injects a predetermined amount of resin into the inside of the mold 50. The injection unit 11 includes a plasticizing cylinder 12 that plasticizes and performs metering of the resin and an injection cylinder 13 that receives the resin delivered from the plasticizing cylinder 12 and that injects the resin into the inside of the mold 50.

The plasticizing cylinder 12 includes a receiving portion 121 for receiving the resin. The receiving portion 121 is disposed on the upstream side in a center line direction in the plasticizing cylinder 12, and receives the resin flowing through the connecting pipe 30 inside the plasticizing cylinder 12. In the receiving portion 121, the end portion of the connecting pipe 30 and a hole provided in the plasticizing cylinder 12 are connected to each other.

The receiving portion 121 only needs to receive the resin flowing through the connecting pipe 30 inside the plasticizing cylinder 12, and thus the configuration is not particularly limited. For example, the end portion of the connecting pipe 30 and the receiving portion 121 of the plasticizing cylinder 12 may be connected to each other using a connecting member such as a coupling (not illustrated). In addition, for example, the end portion of the connecting pipe 30 and the receiving portion 121 of the plasticizing cylinder 12 may be connected by joining the end portion and the receiving portion 121 by welding.

In addition, the plasticizing cylinder 12 includes a screw 122 therein. The screw 122 rotates to feed the resin forward (downstream side in the center line direction). In this case, a metering zone 126 of the plasticizing cylinder 12 performs metering of the resin fed forward by the rotation of the screw 122. As a result, a predetermined amount of resin is fed forward in the plasticizing cylinder 12. When a predetermined amount of resin is accumulated in the vicinity of a delivery port 124 in the plasticizing cylinder 12, the screw 122 advances toward the downstream side in the center line direction. Then, the resin accumulated in the vicinity of the delivery port 124 is pressurized by a tip part 123 of the screw 122 and is delivered to the outside from the delivery port 124.

The control of the screw 122 in the plasticizing cylinder 12 is performed by a screw control unit 125 as a screw controller. For example, the screw control unit 125 enables control of the screw rotation, control of movement (advancement, retreat) in the center line direction, and the like as control of the screw 122. The control of the screw 122 by the screw control unit 125 will be described in detail later.

In addition, the plasticizing cylinder 12 includes a band heater 127 that plasticizes the plasticizing cylinder 12. The band heater 127 is configured to include, for example, a cylindrical heater that is lightweight and thin, in which nichrome wire is insulated with a heat-resistant mica plate and is externally covered with a stainless steel plate, and is disposed on an outer peripheral surface of the plasticizing cylinder 12. Therefore, the plasticizing cylinder 12 plasticizes the resin inside using the heat emitted from the band heater 127.

In addition, the plasticizing cylinder 12 includes a pressure measurement unit 128 as a pressure measurer that measures the pressure applied to the receiving portion 121 of the resin output from the output unit 20. The pressure measurement unit 128 is configured to include a pressure gauge or a pressure sensor. The magnitude of the pressure measured by the pressure measurement unit 128 is used, for example, as information for the screw control unit 125 to control the screw rotation of the screw 122. The amount of resin received in the plasticizing cylinder 12 can also be estimated, based on the magnitude of the pressure measured by the pressure measurement unit 128.

A pipe 129 for causing the resin delivered from the plasticizing cylinder 12 to flow is disposed at an end portion on the downstream side in the center line direction of the plasticizing cylinder 12. The pipe 129 is a metal pipe having a bent portion, and a space 130 serving as a flow path through which the resin delivered from the plasticizing cylinder 12 flows is formed therein. Therefore, the pipe 129 has heat resistance and pressure resistance for causing the resin to flow. Furthermore, an inner surface of the pipe 129 is smooth and has a non-staying structure in which the resin is unlikely to stay.

The injection cylinder 13 receives the resin fed from the plasticizing cylinder 12 into the inside via the pipe 129. A plunger 131 disposed inside the injection cylinder 13 advances toward the downstream side in the center line direction to pressurize the resin with which the injection cylinder 13 is filled. As a result, the resin pressurized by the plunger 131 is injected to the outside from an injection port 132. Specifically, as illustrated by an arrow in FIG. 1, the resin is injected in a state where the injection port 132 of the injection cylinder 13 is brought into contact with the mold 50.

### Mold 50

The mold 50 includes a sprue 51, which is a flow path into which the resin injected from the injection cylinder 13 flows, and an inlet 52 of the sprue 51. When the resin is injected from the injection port 132 in a state where the injection port 132 of the injection cylinder 13 and the inlet 52 of the sprue 51 are in contact with each other, the resin injected flows through the sprue 51 and flows into the inside of the mold 50. The mold 50 completes a molding product (for example, a product or a preform of the product) by molding a resin that flows into the inside by a mold opening and closing operation and cooling and solidifying the resin. The mold opening and closing operation of the mold 50 is performed by a mold clamping unit (not illustrated).

### Output Unit 20

As described above, the output unit 20 is a unit that outputs the resin to the injection molding machine 10. For example, the output unit 20 may be a unit that decontaminates contaminants contained inside the resin of a PET bottle or the like to be recycled using a method such as mechanical recycling (physical regeneration method) or chemical recycling (chemical regeneration method), and outputs the decontaminated resin as a molten resin. The output unit 20 is connected to the connecting pipe 30. Therefore, the resin output from the output unit 20 is received in the plasticizing cylinder 12 of the injection unit 11 of the injection molding machine 10 via the connecting pipe 30.

Here, the “mechanical recycling” refers to a series of treatments such as making a resin such as a recovered used PET bottle into a molten resin by exposing the resin to a high temperature, and diffusing and decontaminating contaminants staying inside the resin in a vacuum in the output unit 20. In addition, the “chemical recycling” refers to a series of treatments of sorting, decomposing, and re-polymerizing a resin such as a recovered used PET bottle to decontaminate contaminants.

### Control of Screw 122

As described above, the plasticizing cylinder 12 constituting the injection unit 11 of the injection molding machine 10 feeds the resin received into the inside by the receiving portion 121 forward (downstream side in the center line direction) by the rotation of the screw 122 while plasticizing the resin. In this case, the plasticizing cylinder 12 performs metering of the resin that is fed forward inside the plasticizing cylinder 12. When a predetermined amount of resin is accumulated in the vicinity of the delivery port 124 inside the plasticizing cylinder 12, the plasticizing cylinder 12 advances the screw 122 to deliver the resin from the delivery port 124 to the outside.

Here, the screw 122 rotates in the same manner as when performing metering of the resin, even when the screw 122 advances to deliver the resin from the delivery port 124. That is, the screw control unit 125 of the plasticizing cylinder 12 advances the screw 122 to deliver the resin from the delivery port 124 while rotating the screw 122 in the same direction as the rotation direction of the screw 122 when the resin is metered by the metering zone 126. That is, even when the screw 122 advances to deliver the resin from the delivery port 124, a state in which the resin can be fed from rearward (upstream side in the center line direction) to forward (downstream side in the center line direction) of the plasticizing cylinder 12 is maintained.

The screw control unit 125 of the plasticizing cylinder 12 enables various controls of the screw 122. For example, the screw control unit 125 can control the rotational speed of the screw 122 so that the rotational speed of the screw 122 when the resin is metered by the metering zone 126 and the rotational speed of the screw 122 when the screw 122 advances to deliver the resin are substantially the same. Here, the rotational speed being substantially the same means that there is no difference in the rotational speed of the screw 122 when the resin is metered and when the resin is delivered, or that there is a difference in the rotational speed, but the difference is small.

In addition, for example, the screw control unit 125 can change the rotational speed of the screw 122 in response to a change in the amount of resin received in the receiving portion 121 of the plasticizing cylinder 12, and the amount of resin received and the amount of resin delivered from the plasticizing cylinder 12 can be controlled to be substantially the same. Here, the fact that the amount of resin received and the amount of resin delivered are substantially the same means that the amount of resin received and the amount of resin delivered are the same, or that there is a difference between the amount of resin received and the amount of resin delivered, but the difference is small.

In addition, for example, the screw control unit 125 can control the rotational speed of the screw 122 in response to the magnitude of the pressure applied to the receiving portion 121 measured by the pressure measurement unit 128. For example, the screw control unit 125 performs control to increase the rotational speed of the screw 122 when the magnitude of the pressure measured by the pressure measurement unit 128 is larger than a predetermined magnitude. In addition, the screw control unit 125 performs control to reduce the rotational speed of the screw 122 when the magnitude of the pressure measured by the pressure measurement unit 128 is smaller than a predetermined magnitude. Here, the magnitude of the predetermined pressure may not be one value, but may have a range.

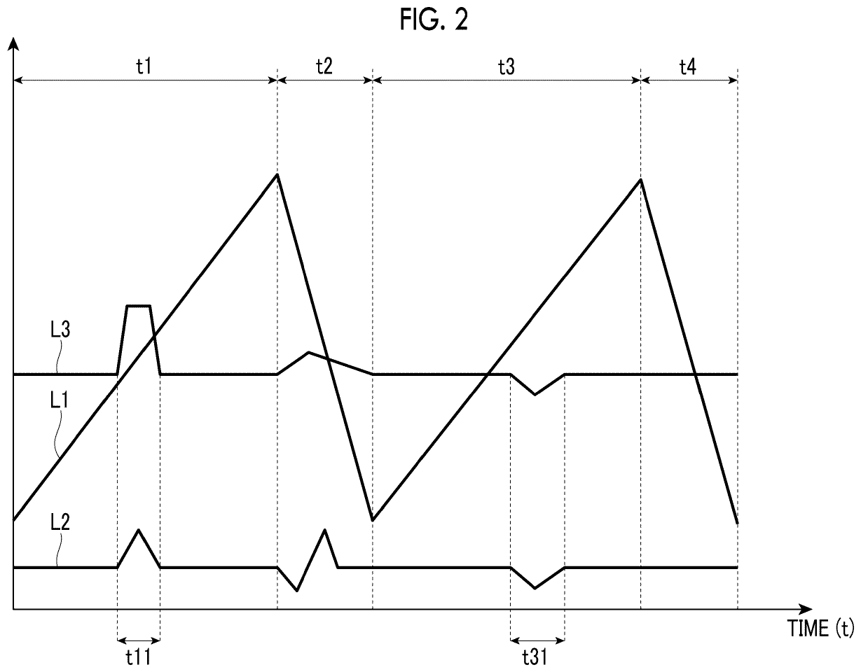

FIG. 2 is a graph illustrating the course of time of a control of the screw 122 by the screw control unit 125 of FIG. 1.

In the graph of FIG. 2, a horizontal axis indicates time (t). Each of time periods t1 and t3 indicates the time period during which the resin is metered by the metering zone 126 of the plasticizing cylinder 12 in FIG. 1. In addition, each of time periods t2 and t4 indicates the time period during which the resin is delivered from the plasticizing cylinder 12 and the injection cylinder 13 of FIG. 1 is filled with the resin.

In addition, in the graph of FIG. 2, a vertical axis indicates any of the rotational speed of the screw 122 of the plasticizing cylinder 12 of FIG. 1, the position of the screw 122 in the center line direction in the plasticizing cylinder 12, and the pressure applied to the receiving portion 121 of the plasticizing cylinder 12. A line L1 indicates the change over time in the position of the screw 122 in the center line direction in the plasticizing cylinder 12. In this case, the position of the screw 122 in the center line direction is located more on the upstream side (rearward), the higher the position is on the vertical axis, and the position of the screw 122 in the center line direction is located more on the downstream side (forward), the lower the position is on the vertical axis.

As illustrated in FIG. 2, all the shapes of the line L1 in the time periods t1 and t3 have a linear shape extending in an upper right direction of the graph. In addition, all the shapes of the line L1 in the time periods t2 and t4 have a linear shape extending in a lower right direction of the graph. This is because the position of the screw 122 in the center line direction is controlled to retreat from the downstream side (forward) to the upstream side (rearward) during the time periods t1 and t3 when the resin is metered. In addition, this is because the position of the screw 122 in the center line direction is controlled to advance from the upstream side (rearward) to the downstream side (forward) during the time periods t2 and t4 in which the injection cylinder 13 is filled with the resin.

In addition, a line L2 indicates the change over time in the magnitude of the pressure applied to the receiving portion 121 of the resin output from the output unit 20 of FIG. 1, which is measured by the pressure measurement unit 128 of the plasticizing cylinder 12 of FIG. 1. In this case, the vertical axis of the graph in FIG. 2 indicates that the pressure applied to the receiving portion 121 increases toward an upper side. The magnitude of the pressure applied to the receiving portion 121 is controlled to be constant by controlling the rotational speed of the screw 122.

In addition, a line L3 indicates the change over time in the rotational speed of the screw 122. In this case, the vertical axis of the graph in FIG. 2 indicates that the rotational speed of the screw 122 increases toward the upper side. The rotational speed of the screw 122 is controlled in response to the magnitude of the pressure applied to the receiving portion 121. That is, the rotational speed of the screw 122 is controlled so that the pressure applied to the receiving portion 121 and the rotational speed of the screw 122 have a proportional relationship. Therefore, the shape of the line L3 has a shape similar to the shape of the line L2. This is because when the pressure applied to the receiving portion 121 increases, the rotational speed of the screw 122 is controlled to be increased in response thereto, and when the pressure applied to the receiving portion 121 decreases, the rotational speed of the screw 122 is controlled to be decreased in response thereto. That is, when the pressure applied to the receiving portion 121 increases, the rotational speed of the screw 122 is controlled to be increased in response thereto. As a result, the resin received by the receiving portion 121 of the plasticizing cylinder 12 is likely to flow to the downstream side (forward). As a result, the pressure applied to the receiving portion 121 decreases and returns to the original level.

On the other hand, when the pressure applied to the receiving portion 121 is decreased, a resin may flow back (backflow). Therefore, the rotational speed of the screw 122 is controlled to be decreased in response to a decrease in the pressure applied to the receiving portion 121. As a result, it is difficult for the resin received by the receiving portion 121 of the plasticizing cylinder 12 to flow to the downstream side (forward). As a result, the pressure applied to the receiving portion 121 increases and returns to the original level. In this manner, the rotational speed of the screw 122 is controlled in response to the magnitude of the pressure applied to the receiving portion 121 of the plasticizing cylinder 12. As a result, the pressure applied to the receiving portion 121 is controlled to be constant in response to the pressure applied to the receiving portion 121, as indicated by the line L2 in the graph of FIG. 2.

In the time period t1 illustrated in the graph of FIG. 2, the metering zone 126 of the plasticizing cylinder 12 performs metering of the resin. In addition, the screw control unit 125 of FIG. 1 retreats the screw 122 from the downstream side to the upstream side in the center line direction while rotating the screw 122 in a direction in which the resin is fed to the downstream side (forward) in the center line direction. Furthermore, in a time period t11 in the time period t1, the screw control unit 125 changes the rotational speed of the screw 122 in response to a sudden change in the pressure applied to the receiving portion 121. As a result, the pressure applied to the receiving portion 121 returns to the original level.

In addition, in the time period t2 illustrated in the graph of FIG. 2, the screw control unit 125 advances the screw 122 to the downstream side in the center line direction while rotating the screw 122 in the direction of feeding the resin to the downstream side (forward) in the center line direction. As a result, the resin is delivered from the delivery port 124 of the plasticizing cylinder 12 and flows through the pipe 129, and the injection cylinder 13 is filled with the resin. Furthermore, the screw control unit 125 changes the rotational speed of the screw 122 in response to a sudden change in the pressure applied to the receiving portion 121. As a result, the pressure applied to the receiving portion 121 returns to the original level.

In addition, in the time period t3 illustrated in the graph of FIG. 2, the metering zone 126 of the plasticizing cylinder 12 performs metering of the resin. In addition, the screw control unit 125 retreats the screw 122 from the downstream side to the upstream side in the center line direction while rotating the screw 122 in a direction in which the resin is fed to the downstream side (forward) in the center line direction. Furthermore, in a time period t31 in the time period t3, the screw control unit 125 changes the rotational speed of the screw 122 in response to a sudden change in the pressure applied to the receiving portion 121. As a result, the pressure applied to the receiving portion 121 returns to the original level. Thereafter, although not illustrated, the same control is repeatedly performed.

As described above, in the injection molding system 1 of FIG. 1, the resin is continuously output from the output unit 20, and the resin is constantly fed to the injection unit 11 of the injection molding machine 10 by flowing through the connecting pipe 30. Therefore, the screw control unit 125 constituting the plasticizing cylinder 12 of the injection unit 11 rotates the screw 122 in a direction of feeding the resin to the downstream side (forward) in the center line direction while controlling the position of the screw 122 in the center line direction. The rotation of the screw 122 continues as long as the amount of resin fed into the plasticizing cylinder 12 is not zero.

Furthermore, the screw control unit 125 changes the rotational speed of the screw 122 in response to a change in the pressure applied to the receiving portion 121 to control the pressure applied to the receiving portion 121 to return to the original level. As a result, the plasticizing cylinder 12 can continuously receive the resin. As a result, for example, the leakage of the molten resin that can be caused by an increase in the pressure of the resin applied to the receiving portion 121 of the plasticizing cylinder 12 from the gap of the plasticizing cylinder 12 can be prevented.

### MODIFICATION EXAMPLE

As described above, the injection unit 11 according to the present embodiment is an injection unit of a so-called pre-plunger type (also referred to as a pre-plasticizing type) in which the independent plasticizing cylinder 12 and the injection cylinder 13 are combined with each other. However, the pre-plunger type injection unit 11 according to the present embodiment is merely an example. For example, an inline screw type injection unit in which plasticizing and injection are performed in one cylinder may be used.

Even in a case of an inline screw type injection unit, the resin is continuously output from the output unit and the resin is constantly fed into the cylinder as in the present embodiment described above. The screw is continuously rotated in the direction of feeding the resin to the downstream side (forward) in the center line direction as long as the amount of resin fed into the cylinder is not zero. As a result, the cylinder of the inline screw type injection unit can continuously receive the resin.

In addition, in the present embodiment, as illustrated in FIG. 1, the pressure measurement unit 128 of the plasticizing cylinder 12 measures the pressure in the vicinity of the receiving portion 121. As a result, it is less necessary to consider the amount of energy lost (pressure loss of the pipe) when the resin output from the output unit 20 flows through the connecting pipe 30. However, the position where the pressure measurement unit 128 measures the pressure is not limited to the vicinity of the receiving portion 121. For example, by prioritizing the ease of measurement over the measurement value of the pressure, a pressure at any position of the connecting pipe 30 may be measured, or a pressure at any position of the output unit 20 may be measured.

In summary, the injection molding machine 10 according to the present embodiment only needs to have the following configuration, and can take various embodiments.

That is, the injection molding machine 10 includes the plasticizing cylinder 12 that continuously receives the resin from the receiving portion 121 into the inside, feeds the resin forward by rotating the screw 122, and delivers the resin fed forward to the outside by advancing the screw 122, in which even when the screw 122 is advanced, the screw 122 is rotated in the same direction as when the resin is fed forward.

That is, even in a state where the resin continuously output from the output unit 20 is constantly fed into the receiving portion 121 of the plasticizing cylinder 12, the resin received is fed forward by the rotation of the screw 122. As a result, the resin is prevented from staying in the vicinity of the receiving portion 121 of the plasticizing cylinder 12. As a result, since an increase in the pressure applied to the receiving portion 121 is prevented, for example, the occurrence of a situation in which the resin leaks from the plasticizing cylinder 12 is prevented.

Here, the injection molding machine 10 may further include the screw control unit 125 as a screw controller that controls the rotational speed of the screw 122.

That is, the rotational speed of the screw 122 is controlled by the screw control unit 125. As a result, the screw control unit 125 changes the rotational speed of the screw 122, so that the resin is prevented from staying in the vicinity of the receiving portion 121.

In addition, the screw control unit 125 may control the rotational speed of the screw 122 so that the rotational speed of the screw 122 when the resin is delivered is substantially the same as the rotational speed of the screw 122 when a predetermined amount of resin is metered.

That is, the rotational speed of the screw 122 when the resin is delivered and the rotational speed of the screw 122 when the predetermined amount of resin is metered are controlled to be substantially the same. As a result, the magnitude of the pressure applied to the receiving portion 121 of the plasticizing cylinder 12 can be kept constant. As a result, for example, a situation in which the resin leaks from the plasticizing cylinder 12 is prevented.

In addition, the screw control unit 125 may change the rotational speed of the screw 122 in response to a change in the amount of resin received in the plasticizing cylinder 12, and control the rotational speed of the screw 122 so that the amount of resin delivered from the plasticizing cylinder 12 is substantially the same as the amount of resin received in the plasticizing cylinder 12.

That is, the rotational speed of the screw 122 is changed in response to the amount of resin received in the plasticizing cylinder 12, and is controlled so that the amount of resin received and the amount of resin delivered are substantially the same. As a result, the flow rate of the resin in the plasticizing cylinder 12 can be adjusted. As a result, for example, a situation in which the resin leaks from the plasticizing cylinder 12 is prevented.

In addition, the injection molding machine 10 may further include the pressure measurement unit 128 that measures the pressure applied to the receiving portion 121 of the resin continuously output from the output unit 20, in which the screw control unit 125 may control the rotational speed of the screw 122 in response to the magnitude of the pressure that is measured.

In addition, the screw control unit 125 performs control to increase the rotational speed of the screw 122 when the magnitude of the pressure measured by the pressure measurement unit 128 is larger than a predetermined magnitude. In addition, the screw control unit 125 may perform control to reduce the rotational speed of the screw 122 when the magnitude of the pressure measured by the pressure measurement unit 128 is smaller than the predetermined magnitude.

That is, when the pressure that is measured increases, the rotational speed of the screw 122 is controlled to be increased in response thereto, and when the pressure that is measured decreases, the rotational speed of the screw 122 is controlled to be decreased in response thereto. As a result, the magnitude of the pressure that is measured is controlled to be constant regardless of the change over time. As a result, for example, a situation in which the resin leaks from the plasticizing cylinder 12 is prevented.

In addition, the injection molding system 1 according to the present embodiment only needs to have the following configuration, and can take various embodiments.

That is, the injection molding system 1 includes the output unit 20 that outputs the resin and the injection molding machine 10 that receives the resin that is output, plasticizes and melts the resin, injects the resin into the mold 50, and molds the resin with the mold 50, in which the injection molding machine 10 includes the plasticizing cylinder 12 that continuously receives the resin from the receiving portion 121 to the inside, feeds the resin forward by rotating the screw 122, and delivers the resin fed forward to the outside by advancing the screw 122, and even when the screw 122 is advanced, the screw 122 is rotated in the same direction as when the resin is fed forward.

It should be understood that the invention is not limited to the above-described embodiment, but may be modified into various forms on the basis of the spirit of the invention. Additionally, the modifications are included in the scope of the invention.

What is claimed is:

1. An injection molding machine comprising:
a plasticizing cylinder that continuously receives a resin from a receiving portion into an inside, feeds the resin forward by rotating a screw, and delivers the resin fed forward to an outside by advancing the screw, wherein
even when the screw is advanced, the screw is rotated in the same direction as when the resin is fed forward.

2. The injection molding machine according to claim 1, wherein
the injection molding machine includes a mold, and an injection unit that plasticizes the resin, performs metering of the resin in a molten state, and injects a predetermined amount of resin into an inside of the mold.

3. The injection molding machine according to claim 2, wherein
the injection unit includes the plasticizing cylinder, and an injection cylinder that receives the resin delivered from the plasticizing cylinder and injects the resin into the inside of the mold.

4. The injection molding machine according to claim 3, wherein
the plasticizing cylinder includes a band heater that plasticizes the plasticizing cylinder.

5. The injection molding machine according to claim 3, wherein
the injection cylinder includes a plunger disposed inside the injection cylinder, and the plunger advances toward a downstream side in a center line direction to pressure the resin with which the injection cylinder is filled.

6. The injection molding machine according to claim 2, wherein
the injection molding machine is connected to an output unit that outputs the resin via a connecting pipe.

7. The injection molding machine according to claim 1, further comprising:
a screw controller that controls a rotational speed of the screw.

8. The injection molding machine according to claim 7, wherein
the screw controller controls the rotational speed of the screw so that the rotational speed of the screw when the resin is delivered is the same as the rotational speed of the screw when a predetermined amount of resin is metered.

9. The injection molding machine according to claim 7, wherein
the screw controller changes the rotational speed of the screw in response to a change in an amount of resin received in the plasticizing cylinder, and controls the rotational speed of the screw so that an amount of resin delivered from the plasticizing cylinder is the same as the amount of resin received.

10. The injection molding machine according to claim 7, further comprising:
a pressure measurer that measures a pressure applied to the receiving portion of the resin, wherein
the screw controller controls the rotational speed of the screw in response to a magnitude of the pressure that is measured.

11. The injection molding machine according to claim 10, wherein
the screw controller performs control to increase the rotational speed when the magnitude of the pressure that is measured is larger than a predetermined magnitude, and performs control to reduce the rotational speed when the magnitude of the pressure that is measured is smaller than the predetermined magnitude.

12. An injection molding system comprising:
an output unit that outputs a resin; and
an injection molding machine that receives the resin that is output, plasticizes and melts the resin, injects the resin into a mold, and molds the resin with the mold, wherein
the injection molding machine includes a plasticizing cylinder that continuously receives the resin from a receiving portion into an inside, feeds the resin forward by rotating a screw, and delivers the resin fed forward to an outside by advancing the screw, and
even when the screw is advanced, the screw is rotated in the same direction as when the resin is fed forward.
